(19) United States
(12) Patent Application Publication
(10) Pub. No.: US 2026/0059587 A1
(43) Pub. Date: Feb. 26, 2026

(54) APPARATUS AND METHOD FOR PACKET FORWARDING IN CONVERGENCE NETWORK OF MOBILE COMMUNICATION SYSTEM

(71) Applicant: ELECTRONICS AND TELECOMMUNICATIONS RESEARCH INSTITUTE, Daejeon (KR)

(72) Inventors: Sun Jin KIM, Sejong-si (KR); Jong Seok LEE, Daejeon (KR); Nam Seok KO, Daejeon (KR)

(73) Assignee: ELECTRONICS AND TELECOMMUNICATIONS RESEARCH INSTITUTE, Daejeon (KR)

(21) Appl. No.: 19/280,629

(22) Filed: Jul. 25, 2025

(30) Foreign Application Priority Data
Aug. 23, 2024 (KR) 10-2024-0113236

(51) Int. Cl. H04W 76/10; H04L 47/20; H04L 47/2441; H04L 47/2483

(52) U.S. Cl. CPC H04W 76/10; H04L 47/20; H04L 47/2441; H04L 47/2483

(57) ABSTRACT

In a method for establishing traffic path in RAN-CN-TN convergence network, the method may include: obtaining, by a SMF, traffic path related information from at least one of a network function (NF) and a TN controller; determining a routing identification (RID) for a traffic through the obtained traffic path related information; generating policy and rule information related to traffic paths based on the RID; and delivering the policy and rule information to at least one of a first type node, the TN controller, and a UE.

### CROSS-REFERENCE TO RELATED APPLICATION

The present application claims priority to Patent Application No. 10-2024-0113236, filed on in Korea Intellectual Property Office on Aug. 23, 2024, the entire contents of which are incorporated herein by reference.

### TECHNICAL FIELD

The present disclosure relates to method and apparatus for packet forwarding in convergence network of mobile communication system.

### BACKGROUND

The content described below merely provides background information related to this embodiment, and does not constitute the prior art.

With the development of 5G mobile technology, various application services based on a network are spreading. These application services are developing into a distributed service structure based on Network Function Virtualization (NFV). However, architecture of a current mobile network is designed without considering a transport layer, and thus could not quickly meet bandwidth and low latency requirements of various application services.

Specifically, an existing communication system structure is separated into a communication device, a wireless access network, and a wired core network through a dedicated system of each of a user equipment (UE), a radio access network (RAN), and a core network (CN), but a physical/logical separation structure may have a signal load problem and a limitation in improving processing performance.

In view of the above problems, a method for virtualizing functional elements of a UE-RAN-CN into an edge cloud environment to integrate redundant functions, and reorganizing an existing network-centric centralized control structure into a user-centric decentralized distributed control structure to deliver user data in a sustainable and scalable next-generation mobile network system, is required below.

### SUMMARY

The present disclosure relates to a method and apparatus for configuring a user data transmission path in a radio access network (RAN)-core network (CN)-transport network (TN) convergence network and delivering user data.

The present disclosure relates to a method and apparatus for configuring user data path based on transport network (TN) controller in RAN-CN-TN convergence network and delivering user data.

The present disclosure relates to a method and apparatus for configuring user data path based on a RAN-CN converged (RCC) user plane function (UPF) in RAN-CN-TN convergence network and delivering user data.

The present disclosure relates to an operation method and apparatus for delivering user data in RAN-CN-TN convergence network.

The present disclosure is directed to a method and apparatus for forwarding buffered data in consideration of UE mobility in RAN-CN-TN convergence network.

The problems to be solved by the present disclosure are not limited to the above-mentioned problems, and other problems that are not mentioned will be clearly understood by those skilled in the art from the following description.

According to an embodiment, in a method for establishing traffic path in RAN-CN-TN convergence network, the method may include: obtaining, by a session management function (SMF), traffic path related information from at least one of a network function (NF) and a TN controller; determining a routing identification (RID) for a traffic through the obtained traffic path related information; generating policy and rule information related to traffic paths based on the RID; and delivering the policy and rule information to at least one of a first type node, the TN controller, and a UE.

In addition, according to an embodiment, in an apparatus for establishing traffic path in RAN-CN-TN convergence network, the apparatus may include: a memory storing at least one program; a transceiver transmitting and receiving at least one signal; and a processor executing the at least one program stored in the memory, wherein the processor may be configured to: obtain traffic path related information from at least one of a network function (NF) and a TN controller; determine a routing identification (RID) for a traffic through the obtained traffic path related information; generate policy and rule information related to traffic paths based on the RID; and deliver the policy and rule information to at least one of a first type node, the TN controller, and a user equipment (UE).

In addition, according to an embodiment, in a method for establishing traffic path in RAN-CN-TN convergence network, the method include: obtaining, by the TN controller, traffic path related information of CN from a session management function (SMF); obtaining, by the TN controller, traffic path related information of TN; determining, by the TN controller, a routing identification (RID) for a traffic based on the traffic path related information of the CN and the traffic path related information of the TN; delivering the RID to the SMF; and receiving policy and rule information related to traffic paths generated from the SMF.

The present disclosure has an effect of providing a method and apparatus for configuring user data transmission path in RAN-CN-TN convergence network and delivering user data.

The present disclosure has an effect of providing a method and apparatus for configuring user data path based on a TN router in RAN-CN-TN convergence network and delivering user data.

The present disclosure has an effect of providing a method and apparatus for configuring user data path based on RCC UPF in RAN-CN-TN convergence network and delivering user data.

The present disclosure has an effect of providing an operation method and apparatus for forwarding user data in RAN-CN-TN convergence network.

The present disclosure has the effect of providing a method and apparatus for delivering buffered data in consideration of UE mobility in RAN-CN-TN convergence network

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 is a conceptual diagram showing a mobile communication system applicable to the present disclosure.

FIG. 2 is a diagram showing an apparatus configuration applicable to the present disclosure.

FIG. 3 is a diagram showing a reference point applicable to the present disclosure.

FIG. 4 is a diagram showing a RAN-CN-TN convergence network structure applicable to the present disclosure.

FIG. 5 is a diagram showing an SBA extension method of UE applicable to the present disclosure.

FIG. 6 is a diagram showing a convergence network applicable to the present disclosure.

FIG. 7 is a diagram showing a method for configuring a user data path applicable to the present disclosure.

FIG. 8 is a diagram showing a method for configuring a user data path applicable to the present disclosure.

FIG. 9 is a diagram showing a packet forwarding operation in a case of establishing a user data path based on a TN router applicable to the present disclosure.

FIG. 10 is a diagram showing a packet forwarding operation in a case of establishing a user data path based on a TN router applicable to the present disclosure.

FIG. 11 is a diagram showing a packet forwarding operation in a case of establishing a user data path based on a cUP applicable to the present disclosure.

FIG. 12 is a diagram showing a packet forwarding operation in a case of establishing a user data path based on a cUP applicable to the present disclosure.

FIG. 13 is a diagram showing a method for delivering buffered data between cUPs based on mobility of a UE applicable to the present disclosure.

FIG. 14 is a flowchart showing a method for establishing a traffic path in a convergence network applicable to the present disclosure.

FIG. 15 is a flowchart showing a method for establishing a traffic path in a convergence network applicable to the present disclosure.

### DETAILED DESCRIPTION

Hereinafter, some embodiments of the present disclosure will be described in detail with reference to the accompanying drawings. In the following description, like reference numerals can designate like elements, even though the elements can be shown in different drawings. Further, the following description of some embodiments can omit, for the purpose of clarity and for brevity, a detailed description of related known components and functions when considered obscuring the subject of the present disclosure.

Various ordinal numbers or alpha codes such as “first”, “second”, “A”, “B”, “(a)”, “(b)”, etc., can be prefixed solely to differentiate one component from the other but not to necessarily imply or suggest the substances, order, or sequence of the components. Throughout this specification, when a part “includes” or “comprises” a component, the part is meant to allow for further including other components and to not exclude other components, unless specifically stated to the contrary. Terms such as “unit,” “module,” and the like can refer to units in which at least one function or operation is processed and they may be implemented by hardware, software, or a combination thereof.

The following detailed description is intended to describe exemplary embodiments of the present invention and is not intended to represent the only embodiments in which the present invention may be practiced.

Hereinafter, some embodiments of the present disclosure will be described in detail with reference to exemplary drawings. Note that when components in each drawing are added by reference symbols, the same components are denoted by the same symbols as much as possible even if they are denoted on different drawings. In addition, in describing the present disclosure, if it is determined that a specific description of a related known configuration or function may obscure the gist of the present disclosure, the detailed description thereof will be omitted.

In describing components of embodiments of the present disclosure, symbols such as first, second, i), ii), a), and b) may be used. These symbols are only used to distinguish the components from other components, and the nature, sequence, order, or the like of those components is not limited by the symbols. In the specification, when a part “includes” or “comprises” a component, unless there is an explicit description to the contrary, the part may further include other components rather than excluding the other components.

The detailed description to be disclosed below in connection with the appended drawings is intended to describe exemplary embodiments of the present disclosure and is not intended to represent the only embodiments in which the present disclosure may be practiced.

Embodiments of the present disclosure relate to a method and apparatus for configuring a path and forwarding a packet in a radio access network (RAN)-core network (CN)-transport network (TN) convergence network.

A communication network to which embodiments according to the present disclosure are applied will be described. The communication network may be a non-terrestrial network (NTN), a 4G communication network (e.g., a long-term evolution (LTE) communication network), a 5G communication network (for example, a new radio (NR) communication network), or the like. In addition, in one embodiment, the next-generation communication network may be a 6G communication network, a communication network in new form, or the like, which is not limited to a specific form. Throughout the specification, the network may be, for example, a wireless internet such as wireless fidelity (WiFi), a portable internet such as wireless broadband internet (WiBro) or world interoperability for microwave access (WiMax), a 2G mobile communication network such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as a long term evolution (LTE) network or an LTE-Advanced network, a 5G mobile communication network of NR, and other next-generation communication networks such as a 6G communication network or other networks, and may not be limited to a specific form.

Throughout the specification, terminals may be referred to as terminal, access terminal, mobile terminal, station, subscriber station, mobile station, portable subscriber station, node, device, and the like.

Here, a terminal may be implemented by a desktop computer, a laptop computer, a tablet personal computer, a wireless phone, a mobile phone, a smart phone, a smart watch, a smart glass, an e-book reader, a portable multimedia player (PMP), a portable game console, a navigation device, a digital camera, digital multimedia broadcasting (DMB) player, a digital audio recorder, a digital audio player, a digital picture recorder, a digital picture player, a digital video recorder, or a digital video player.

Throughout the specification, a base station may be referred to as NodeB, base transceiver station (BTS), radio base station, radio transceiver, access point, access node, road side unit (RSU), digital unit (DU), cloud digital unit (CDU), radio remote head (RRH), radio unit (RU), transmission point (TP), transmission and reception point (TRP), relay node, and the like.

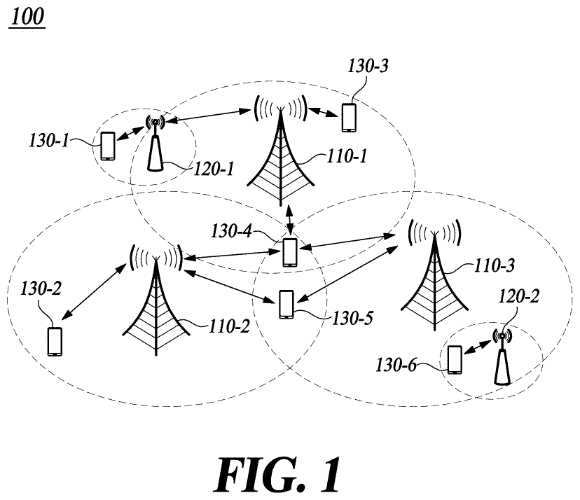

FIG. 1 is a conceptual diagram showing a mobile communication system according to an embodiment.

Referring to FIG. 1, the communication system 100 may include a plurality of communication nodes 110-1, 110-2, 110-3, 120-1, 120-2, 130-1, 130-2, 130-3, 130-4, 130-5, 130-6. The plurality of communication nodes may support 4G communication (e.g., long term evolution (LTE), advanced (LTE-A)), 5G communication (e.g., new radio (NR)), and next-generation communication (e. g., 6G), etc. defined in the 3rd generation partnership project (3 GPP) standard. The 4G communication may be carried out in a frequency band of 6 GHz or less, and the 5G communication may be carried out in a frequency band of 6 GHz or more, as well as a frequency band of 6 GHz or less. In 6G communication, a THz frequency band may be used, artificial intelligence (AI) and other technologies may be applied, which is not limited to a specific form.

For example, for 4G communications, 5G communications, and 6G communications, the plurality of communication nodes may support a code division multiple access (CDMA)-based communication protocol, a wideband CDMA (WCDMA)-based communication protocol, a time division multiple access (TDMA)-based communication protocol, a frequency division multiple access (FDMA)-based communication protocol, an orthogonal frequency division multiplexing (OFDM)-based communication protocol, a filtered OFDM-based communication protocol, a cyclic prefix (CP)-OFDM-based communication protocol, a discrete Fourier transform-spread-OFDM (DFT-s-OFDM) based communication protocol, an orthogonal frequency division multiple access (OFDMA)-based communication protocol, a single carrier (SC)-FDMA-based communication protocol, a non-orthogonal Multiple Access (NOMA), a generalized frequency division multiplexing (GFDM)-based communication protocol, a filter bank multi-carrier (FBMC)-based communication protocol, universal filtered multi-carrier (UFMC)-based communication protocol, a Space Division Multiple Access (SDMA)-based communication protocol, and the like.

In addition, the communication system 100 may further include a core network. When the communication system 100 supports 4G communication, the core network may include a serving-gateway (S-GW), a packet data network (PDN)-gateway (P-GW), a mobility management entity (MME), and the like. When the communication system 100 supports 5G communication, the core network may include a UPF, a session management function (SMF), an access and mobility management function (AMF), and the like. In addition, in one embodiment, when the communication system 100 supports 5G communication, the core network may be configured based on a function based on 5G communication or a new function, and is not limited to a specific form.

On the other hand, each of the plurality of communication nodes 110-1, 110-2, 110-3, 120-1, 120-2, 130-1, 130-2, 130-3, 130-4, 130-5, 130-6 or network functions configuring the communication system 100 may have the following structure.

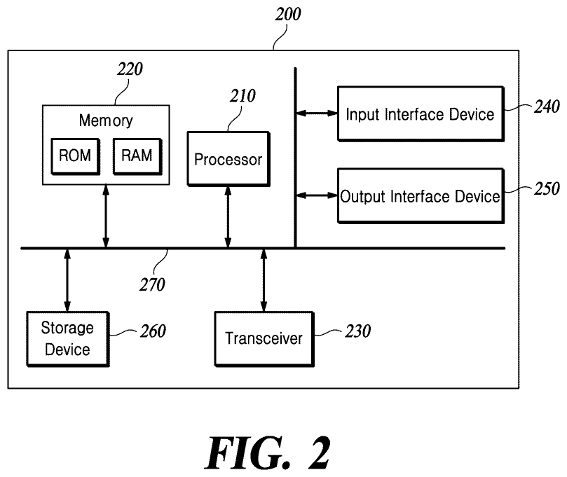

FIG. 2 is a diagram showing an apparatus configuration according to an embodiment. Referring to FIG. 2, the communication node 200 (network function) may include at least one processor 210, a memory 220, and a transceiver 230 connected to a network to perform communication. In addition, the communication node 200 may further include an input interface device 240, an output interface device 250, a storage device 260, and the like. Each component included in the communication node 200 may be connected by a bus 270 to perform communication with each other.

However, each component included in the communication node 200 may also be connected through individual interfaces or individual buses via the processor 210, rather than the common bus 270. For example, the processor 210 may also be connected to at least one of the memory 220, the transceiver 230, the input interface device 240, the output interface device 250, and the storage device 260 through a dedicated interface.

The processor 210 may execute a program command stored in at least one of the memory 220 and the storage device 260. The processor 210 may refer to a central processing unit (CPU), a graphics processing unit (GPU), or a dedicated processor in which methods according to embodiments of the present disclosure are performed. Each of the memory 220 and the storage device 260 may be configured as at least one of a volatile storage medium and a nonvolatile storage medium. For example, the memory 220 may be configured as at least one of a read only memory (ROM) and a random access memory (RAM).

Referring back to FIG. 1, the communication system 100 may include a plurality of base stations 110-1, 110-2, 110-3, 120-1, 120-2 and a plurality of terminals 130-1, 130-2, 130-3, 130-4, 130-5, 130-6. The communication system 100 including the base stations 110-1, 110-2, 110-3, 120-1, 120-2 and the terminals 130-1, 130-2, 130-3, 130-4, 130-5, 130-6 may be referred to as an “access network.” Each of the first base station 110-1, the second base station 110-2, and the third base station 110-3 may form a macro cell. Each of the fourth base station 120-1 and the fifth base station 120-2 may form a small cell. The fourth base station 120-1, the third terminal 130-3, and the fourth terminal 130-4 may belong to cell coverage of the first base station 110-1. The second terminal 130-2, the fourth terminal 130-4, and the fifth terminal 130-5 may belong to the cell coverage of the second base station 110-2. The fifth base station 120-2, the fourth terminal 130-4, the fifth terminal 130-5, and the sixth terminal 130-6 may belong to the cell coverage of the third base station 110-3. The first terminal 130-1 may belong to the cell coverage of the fourth base station 120-1. The sixth terminal 130-6 may belong to the cell coverage of the fifth base station 120-2.

Here, each of the plurality of base stations 110-1, 110-2, 110-3, 120-1, 120-2 may be referred to as a NodeB, an evolved NodeB, a gNB, an xNB, a base transceiver station (BTS), a radio base station, a radio transceiver, an access point, an access node, or the like. Each of the plurality of terminals 130-1, 130-2, 130-3, 130-4, 130-5, 130-6 may be referred to as a user equipment (UE), a terminal, an access terminal, a mobile terminal, a station, a subscriber station, a mobile station, a portable subscriber station, node, device, or the like.

Meanwhile, each of the plurality of base stations 110-1, 110-2, 110-3, 120-1, 120-2 may operate in a different frequency band, or may operate in the same frequency band. Each of the plurality of base stations 110-1, 110-2, 110-3, 120-1, 120-2 may be connected to each other through an ideal backhaul link or a non-ideal backhaul link, and may exchange information with each other through the ideal backhaul link or the non-ideal backhaul link. Each of the plurality of base stations 110-1, 110-2, 110-3, 120-1, 120-2 may be connected with the core network via an ideal backhaul link or a non-ideal backhaul link. Each of the plurality of base stations 110-1, 110-2, 110-3, 120-1, 120-2 may transmit a signal received from the core network to the corresponding terminal 130-1, 130-2, 130-3, 130-4, 130-5, 130-6, and may transmit a signal received from the corresponding terminal 130-1, 130-2, 130-3, 130-4, 130-5, 130-6 to the core network.

In addition, in one embodiment, a core network of a communication system is configured with an architecture based on interaction between network functions (NFs). In one embodiment, a core network of a 5G system, such as a 5GC, may include various entities. Specifically, an access and mobility management function (AMF) may manage access and mobility of the terminal. The AMF may perform a non-access stratum (NAS) security management and a mobility management function of the idle state terminal.

A session management function (SMF) may manage a session. In one embodiment, the SMF may perform a function of allocating a terminal internet protocol (IP) address and control a protocol data unit (PDU) session.

In addition, a policy control function (PCF) may perform a function of controlling a policy. It may also include a UPF that performs the function of controlling the user plane. The UPF is a function of a gateway for transmitting and receiving data, and may perform all or some of user plane functions of a serving gateway (S-GW) and a packet data network gateway (P-GW) of the previous mobile communication system 4G. In addition, the UPF may perform a function of handling the PDU. In addition, an application function (AF) for controlling an application function may be included. The AF may be a function for providing a plurality of services to the terminal. In addition, it may include a unified data management (UDM) for managing integrated data.

In addition, in one embodiment, a core network of a next-generation system (for example, 6G) may be referred to by the same name as a function in the same form as a function of the 5G system, or may be configured as a new entity (or function) based on the next-generation system, which is not limited to a specific embodiment. However, in the next-generation system, as described above, functions for managing terminal access and mobility or managing a session may be configured, and the matters described below may be applied in the same manner. Hereinafter, for the convenience of explanation, the description is based on the 5G system, however it is not limited thereto and may equally apply to the next-generation system.

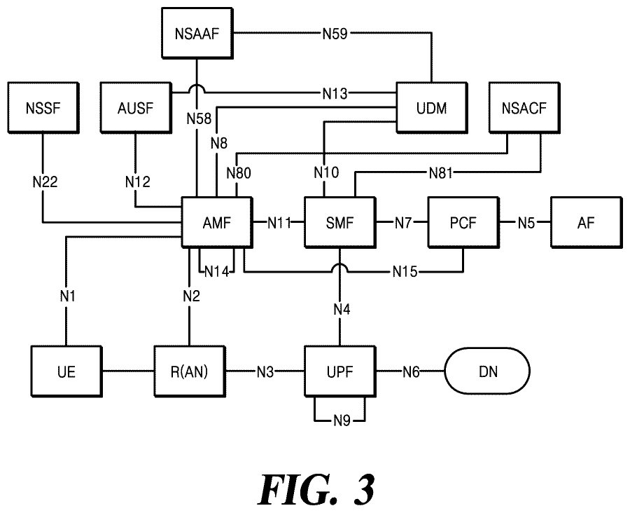

FIG. 3 is a diagram showing a reference point according to an embodiment of the present disclosure. Referring to FIG. 3, a reference point may indicate interaction between NF services in NFs described by a point-to-point reference point between two network functions (NFs). In one embodiment, N1 may be a reference point between a terminal UE and an access management function (AMF). N2 may be a reference point between (R)AN and AMF. N3 may be a reference point between (R)AN and UPF. Other reference points may be as shown in Table 1 below but are not limited thereto.

TABLE 1
N1: Reference point between the UE and the AMF.
N2: Reference point between the (R)AN and the AMF.
N3: Reference point between the (R)AN and the UPF.
N4: Reference point between the SMF and the UPF.
N5: Reference point between the PCF and an AF or TSN AF.
N6: Reference point between the UPF and a Data Network.
N7: Reference point between the SMF and the PCF.
N8: Reference point between the UDM and the AMF.
N9: Reference point between two UPFs.
N10: Reference point between the UDM and the SMF.
N11: Reference point between the AMF and the SMF.
N12: Reference point between AMF and AUSF.
N13: Reference point between the UDM and Authentication Server
function the AUSF.
N14: Reference point between two AMFs.
N15: Reference point between the PCF and the AMF in the case of
non-roaming scenario, PCF in the visited network and AMF in the
case of roaming scenario.
N16: Reference point between two SMFs, (in roaming case between
SMF in the visited network and the SMF in the home network).
N16a: Reference point between SMF and I-SMF.
N17: Reference point between AMF and 5G-EIR.
N18: Reference point between any NF and UDSF.
N19: Reference point between two PSA UPFs for 5G LAN-type service.
N22: Reference point between AMF and NSSF.

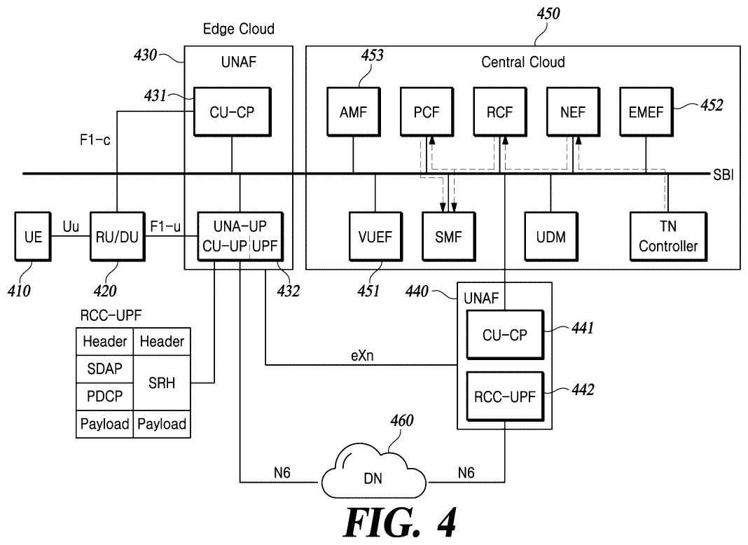

FIG. 4 is a diagram showing a RAN-CN-TN convergence network structure applicable to the present disclosure.

In one embodiment, as described above, in the existing communication system, the communication device, the radio access network, and the wired core network may be configured separately through dedicated systems for the UE, RAN, and CN, respectively. Here, in a physical/logical separation structure of an existing communication system, there may be a signal load problem or a limitation of processing performance. In one embodiment, in the existing communication system structure in which functions of the UE, RAN, and CN are separated, control signal transmission delay may occur due to several protocol conversions and redundant processing in a mobile network. In addition, a bottleneck may occur in which multiple signals are concentrated to a particular anchor point. In another embodiment, the mobile network requires extensive signaling to maintain a protocol data unit (PDU) session in which a transmission control protocol (TCP) connection is in operation, and there may be a problem that signaling overload occurs in a CN when a large number of machine type communications (MTC) devices, such as an unmanned aerial vehicle or an autonomous vehicle, attempt to connect to the network at the same time.

Considering the aforementioned points, the following describes the operation of configuring a user data path based on a convergence network that integrates redundant functions by virtualizing the functional elements of UE-RAN-CN providing mobile communication services in an edge cloud environment, and delivering user data. In one embodiment, the convergence network may be a user-centric decentralized distributed control structure, different from an existing centralized control structure, thereby enabling the construction of a scalable communication system. The following describes a method for forwarding a packet with reference to a convergence network of the RAN-CN-TN considering the aforementioned points, and for convenience of explanation, the RAN-CN-TN convergence network is referred to as a convergence network.

As a more specific embodiment, referring to FIG. 4, the UE 410 may be connected to a base station in a RAN-CN-TN convergence network (hereinafter, referred to as a convergence network). Here, the base station may be configured to be separated into a radio unit (RU)/distributed unit (DU) and a central unit (CU). The UE 410 may be connected to the RU/DU 420 through a Uu interface, and the RU/DU 420 may be connected to a CU through an F1 interface, but it is not limited in this embodiment. In addition, the convergence network may include a united network anchor function (UNAF) 430, 440 that integrates and controls wired and wireless resources by unifying dualized or redundant functions in the wireless and wired sections on the cloud. Control planes of the UNAFs 430, 440 may be control planes (CPs) 431, 441 of CU, and UNA-UPs 432, 442, which are user planes (UPs) 432, 442 of the UNAF, may be configured as a RAN-CN converged-UPF (RCC-UPF) 432 in which the CU-UP and the UPF are integrated. That is, a UPF in a converged form of the RAN and CN may be configured. Here, an eXn interface (evolved Xn, eXn) may be formed between the UNAFs 430, 440. In addition, the RCC-UPFs 432, 442 of the UNAFs 430, 440 may be connected to a data network (DN) 460 via the N6 interface, but it is not limited thereto. A format for indicating a traffic path according to a routing identification (RID) in the RCC-UPF 432, 442 may further include SRv6 header (SRH) in addition to the IPv6 header and the IPv6 payload. In one embodiment, the SRH may include segment identifier (SID) information for each path based on the traffic path, and it may not be limited to a specific embodiment.

In one embodiment, the convergence network may include a virtualized user equipment function (VUEF) 451 that digitally twins state information of the UE 410 to handle the processing of the network service request of the UE 410 and control information synchronization with the UE 410. Most of the information of the UE 410 required in the network is synchronized with the VUEF 451 that is digitally twinned, so that the information capacity transmitted and received in the radio section may be reduced and redundant information delivery may be eliminated. In addition, in one embodiment, the convergence network may include an evolved message exchange function (EMEF) 452 as an event-based message exchange interface function that provides a message transfer function between core network functions including the UE 410. However, the above-described structure of the convergence network is only an example, and the configurations may be omitted, and are not limited to a specific form.

In one embodiment, the UNAF 430, 440 may interact with the digital twin VUEF 451 of the UE 410 to perform a network service. The UNAFs 430, 440 may be consisted of UNA-CPs 431, 441, which integratively controls the wireless resource establishment with the UE 410 and the mobile core network resource establishment, and UNA-UPs 432, 442, which forwards the user data of the UE 410 and delivers it to the DN 460.

Here, in one embodiment, when the UE 410 selects an indirect interworking scheme via the AMF 453, the UNA-CPs 431, 441 may provide control signaling through an existing scheme (e.g., a non-access stratum (NAS)). On the other hand, when the UE 410 selects a direct interworking scheme through a service based interface (SBI), the UNA-CPs 431, 441 may selectively provide control signaling through the EMEF 452.

In one embodiment, the SBI may be an interface that operates based on service based architecture (SBA). Specifically, although the 5G mobile core of FIGS. 1 to 3 described above is designed as a single structure, a core network may be designed as service-based architecture after 5G (e.g., 6G). The network may be configured as a network function, which is a software component that operates based on interactions, thereby providing horizontal scalability and flexibility to meet various detailed requirements. The mobile core network may operate based on a maturing cloud-native technology in which network functions are deployed in multiple distributed clouds. Here, the current 5G mobile core structure has limitations in supporting cloud-native technology, and thus a paradigm shift may be required, and the core network may be designed as the SBA-based network described above. The SBA-based core network is a software component having various functions, and may be decomposed into a network function (NF) and included. Here, the NF may expose a service in a form of a restful application programming interface (API). That is, a flexible and scalable deployment may be possible if the network is decomposed into NFs that are software components, thereby having a service-based architecture. In addition, in one embodiment, in an SBA-based core network, NFs may be containerized and deployed in multiple clouds, enabling resource sharing and dynamic allocation for service operations through cloud technology. As described above, a flexible and scalable core network may be constructed, enabling the provision of various services.

In one embodiment, various types of services are expected to emerge after 5G, and considering the above-mentioned services, the core network needs to be designed on an SBA basis. Based on the current 5G core network, the signaling procedure for the terminal may be in a form in which some steps of the procedure are processed and operated in each NF based on the NF chain. That is, the NFs may constitute a static connection relationship between the NFs. However, it is necessary to enable automatic discovery in consideration of NF discovery and selection operations in a large-scale dynamic structure. In one embodiment, a network repository function (NRF) currently exists in the 5G core network, and an NF may be registered in the NRF. The NF may transmit a query to the NRF to request a service and select another NF in response thereto. Here, in one embodiment, it is difficult to include service discovery and selection logic within each of NFs, and a service communication proxy (SCP) may be utilized in consideration of the aforementioned points. The SCP may instead perform service discovery and selection of the NF, to relieve a burden of performing service discovery and selection directly in the NF. However, even when service discovery and selection is performed by the SCP, NFs need to be registered and discovered in the NRF. That is, service discovery and selection may be performed in a centralized manner based on the NRF. In one embodiment, centralized service discovery and selection may cause bottlenecks in control plane traffic, and delays may occur due to multiple signal discovery procedures, which may present limitations.

Here, in an environment in which service types are diversified and the number of service types is increased after 5G, the above-described SBA-based core network may be required in a new form, and the SBA-based core network may be enabled to perform corresponding functions without the above-described NRF and SCP. In one embodiment, when operating based on an SBA-based core network, the role of selecting the appropriate instance of the target service within the application context may be performed by the service agent and the service controller, and common logic for NF discovery and selection may be included in the service agent. That is, all network functions may be connected to a service agent that has a proxy role to perform service request and response instead, and the service agent may perform all service registration/discovery and selection in signal logic of the network function.

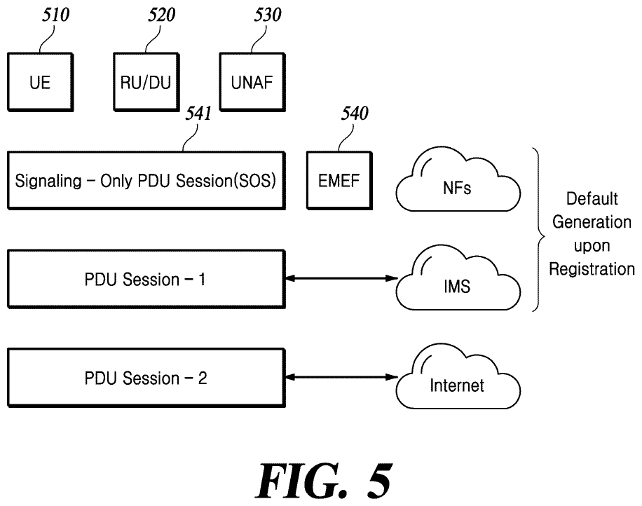

FIG. 5 is a diagram showing an SBA extension method of UE applicable to the present disclosure.

Referring to FIG. 5, a digital twin device based UE 510 may perform initial registration with the convergence network. In addition, the convergence network may include, but is not limited to, the RU/DU 520, the UNAF 530, and the EMEF 540. Here, the UE 510 may establish and activate a (control) signal-only PDU session signal only session (SOS) 541 capable of exchanging SBI-based control signal information with the core network. In one embodiment, the signal-only PDU session SOS 541 may be generated by establishing a uniform resource identifier (URI) of the EMEF 540, which is disposed at the entry point of a public land mobile network (PLMN) cloud in which core network functions are disposed and provides a relay function of message delivery, as an access point name (APN), and may be performed in the same manner as other PDU session establishment procedures.

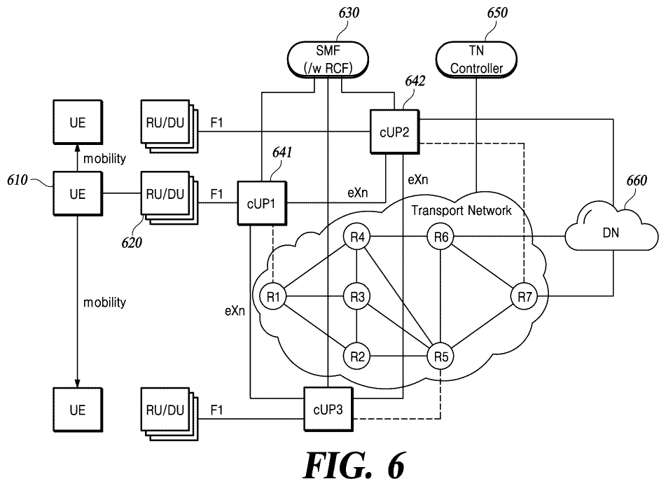

FIG. 6 is a diagram showing a convergence network applicable to the present disclosure.

Referring to FIG. 6, the convergence network may be a convergence network of RAN-CN-TN, as described above. Here, the UNAF described above may be configured based on the edge cloud in a form in which the RAN and CN are integrated. Here, the UNA-UP may be configured as a RAN CN converged (RCC)-UPF in a form in which the CU-UP and the UPF are converged. That is, a UPF based on the integration of the RAN and CN may be configured, and an operation based thereon may be performed. In the following, the UPF of the RAN and CN integration is referred to as a cUP for convenience of explanation, but this is only a configuration for convenience of explanation and is not limited to this name. The cUPs may be interconnected via an eXn interface. In one embodiment, considering that the UPF is in a converged form of the RAN and CN, the interface between them is referred to as eXn, but this is only for convenience of explanation and may not be limited thereto. Note that eXn is referred to below for convenience of explanation. In addition, in one embodiment, in FIG. 4 and FIG. 6, the base station may have a structure separated into a radio unit (RU)/distributed unit (DU) and a central unit (CU), and the UNAF may be configured the CU-CP and as the above-described UNA-UP, which consists of the CU-UP and the UPF, as described above. The RU/DU and CU-CP may be connected based on the F1-c interface, and the RU/DU and UNA-UP may be connected based on the F1-u interface. Hereinafter, the description is based on a base station structure separated into RU/DU and CU, but it is not limited thereto.

Referring to FIG. 6, the UE 610 may operate based on a convergence network. Specifically, the UE 610 is connected to the RU/DU 620 based on mobility, and the RU/DU 620 may be connected to each of the cUPs 641, 642. Here, the data delivery path of the user data associated with the UE 610 may be controlled by the SMF 630, and the SMF 630) may be connected to each of the cUPs 641, 642. In addition, since the RAN, CN, and TN are convergence networks, respective NFs in the network may be connected to a TN controller 650. Here, referring to FIG. 6, the TN controller 650 may exchange information with other NFs in a network through a network exposure function (NEF). In another embodiment, the RAN, CN, and TN convergence networks may operate based on the SBI described above and may not be limited to a particular form. The routers (R1 to R7) form a Transport Network (TN), and the TN controller (650) can recognize topology information (e.g., the connection structure of the routers R1 to R7 that consist of the TN) and path information through which a data packet is delivered, and may control a data packet delivery path based on the topology information and the path information. In addition, respective cUPs 641, 642 controlled by the SMF 630 may forward the data packet by checking a path through which the data packet is delivered based on information obtained from the SMF. In one embodiment, the RAN-CN-TN convergence network may be a network configured based on FIG. 4 and FIG. 6, and a method for delivering data packet in the convergence network is described below.

In the convergence network, the user data may be generated based on the SMF. Specifically, the SMF may obtain IPv6 addresses of a source (UE) and a destination (DN) for transmitted user data, and obtain necessary information related to data path configuration with at least one NF of the CN. In a specific embodiment, the SMF may obtain information related to user data path configuration from the TN controller through a network exposure function (NEF). Then, the SMF may calculate a path through a routing control function (RCF). In one embodiment, the RCF may be a network function that generates an optimal data (or traffic) path, but may not be limited to that name. A network function that performs the same function as the RCF may be defined by another name. In addition, the RCF function may be an individual network function, but is not limited thereto. In one embodiment, the RCF may be a network function that is combined with or included in another network function. The following description is based on the RCF as an individual network function for convenience of explanation, but is not limited thereto.

The RCF may obtain information related to user data path calculation from the SMF or other network function to calculate a path for the user data. In one embodiment, the RCF may obtain the load information through a network function, and calculate a path of the user data by reflecting the load information, which is not limited to a specific form. The RCF may calculate the user data path based on user data path related information obtained from at least one of the SMF and other network functions. In one embodiment, the user data path may be generated for each application, and a routing identification (RID) corresponding to each traffic path generated for each application may be assigned, but may not be limited thereto.

Upon obtaining the user data path information calculated from the RCF, the SMF may deliver rules (e.g., packet detection rule (PDR), enhanced forwarding action rule (eFAR), QoS enforcement rule (QER), and usage report rule (URR)), policies (e.g, traffic classification (TC)), and other information necessary for data delivery to at least one cUP and TN controller. Also, in one embodiment, the SMF may, but may not be limited to, communicate rules (e.g., PDR, eFAR), policies (e.g, TC), and other information necessary for user data delivery to the UE. That is, the SMF may establish the PDR as a rule for recognizing the packet and the eFAR as a rule for forwarding the packet to deliver the user data to each cUP and the TN controller, but is not limited thereto.

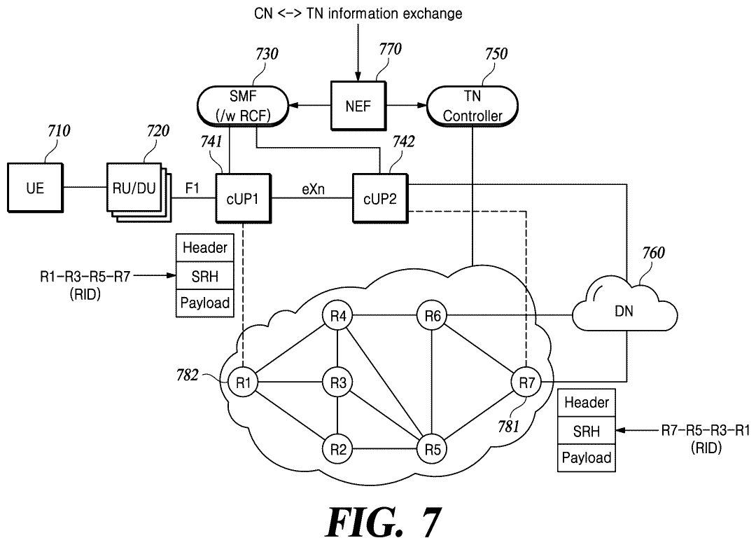

FIG. 7 is a diagram showing a method for configuring a user data path applicable to the present disclosure.

Referring to FIG. 7, the UE 710 may be connected to an RU/DU 720, and each of the RU/DUs 720 may be connected to a cUP 741. The SMF 730 may obtain information related to the user data path from at least one of a network function of the CN and the TN controller 750. In one embodiment, the SMF 730 may obtain at least one of topology information, load information, and other information from at least one network function of the CN. In another embodiment, the SMF 730 may exchange necessary information with the TN controller 750 through the NEF 770. In the convergence network, the RAN, CN, and TN may have an integrated structure, and the SMF 730 and the TN controller 750 may perform information exchange through mutual requests and responses. In a specific embodiment, the SMF 730 and the TN controller 750 may exchange information with each other through the NEF 770 based on a policy level agreement, but is not limited thereto. The TN controller 750 may collect TN topology information, TN load information, performance information, and other TN-related information, and may deliver the collected information to the SMF 730 through the NEF 770.

Then, the SMF 730 may transfer the user data path calculation-related information to the RCF, and the RCF may calculate a path for the user data based on the user data path calculation-related information and transfer the path to the SMF 730). In one embodiment, the path that the RCF calculates may be returned to the RID. In FIG. 7, user data may be transferred from the DN 760 to the UE 710 or from the UE 710 to the DN 760 via a path of R1-R3-R5-R7. Here, the path through which the user data is delivered may be indicated by the RID. However, the name of the RID is only an example, and is not limited to the name. After the RID corresponding to the user data path is generated in the RCF and returned to the SMF 730, the SMF 730 may generate a rule and a policy for user data transmission based on the RID, and transmit the related information to at least one of the cUPs 741, 742, the TN controller 750, and the UE 710. The TN controller 750 transmits the received rule and policy information to the R7 781. The R7 781 may configure an IPv6 payload, an SRH, and an IPv6 header for the data obtained from the DN 760 based on the rule and policy information received from the TN controller 750 so that downlink transmission for the user data is performed through another router in the TN. In one embodiment, the SRH may include an RID, and a path through which the user data is transmitted may be determined based on the RID. In FIG. 4 and FIGS. 7 through 13, the “payload” represents the IPv6 payload, and the “Header” represents the IPv6 header.

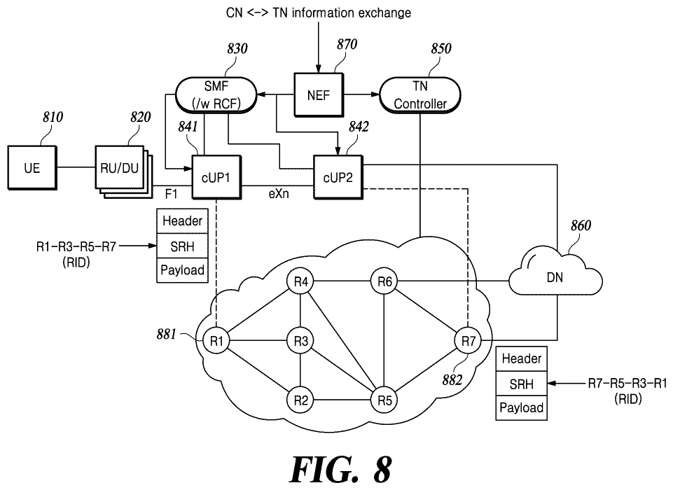

FIG. 8 is a diagram showing a method for configuring a user data path applicable to the present disclosure.

Referring to FIG. 8, the UE 810 may be connected to the RU/DU 820, and each of the RU/DUs 820 may be connected to the cUP. The SMF 830 may obtain CN information related to the user data path from at least one network function of the CN. In one embodiment, the SMF 830 may obtain at least one of topology information, load information, and other information from at least one network function of the CN. Here, the SMF 830 and the TN controller 850 may perform information exchange through mutual request and response based on the convergence network. In a specific embodiment, the SMF 830 and the TN controller 850 may exchange information with each other through the NEF 870 based on a policy level agreement, but is not limited thereto. That is, the SMF 830 may deliver the obtained CN information to the TN controller 850 through the NEF 870.

In addition, the TN controller 850 may collect TN topology information, TN load information, performance information, and other TN-related information. The TN controller 850 may obtain the CN information from the SMF 830 through the NEF 870, directly obtain the TN information, and then calculate a user data path based thereon to generate the RID. The RID information generated from the TN controller 850 may then be delivered to the SMF 830 via the NEF 870. In a specific embodiment, although FIG. 8 is described with reference to an RID indicating that user data is delivered from the UE 810 to the DN 860 via path of R1-R3-R5-R7 or delivered from the DN 860 to the UE 810 via path of R1-R3-R5-R7, this is merely an example for convenience of explanation, and is not limited thereto. The SMF 830 may generate a user data path related rule and policy based on the RID obtained from the TN controller 850, and transmit the related information to at least one of the cUPs 841, 842, the TN controllers 850, and the UE 810.

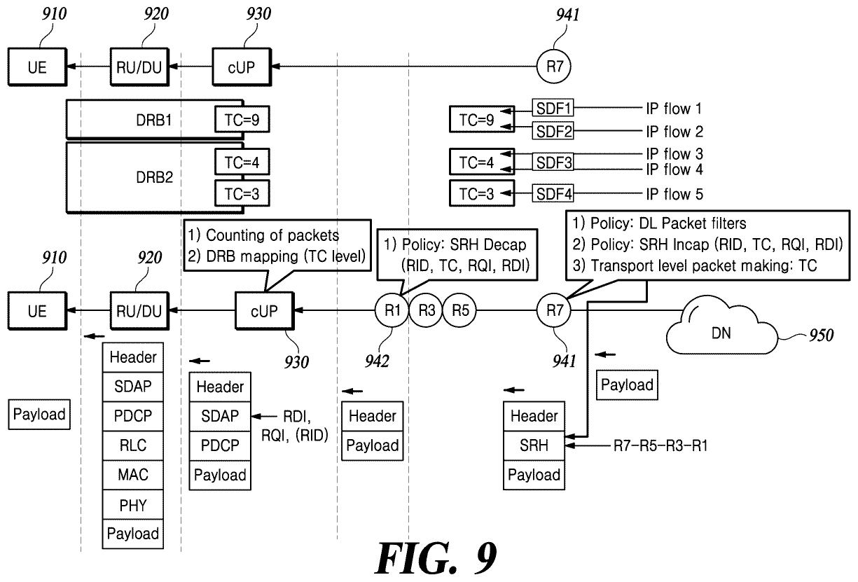

FIG. 9 is a diagram showing a packet forwarding operation in a case of establishing a user data path based on a TN router applicable to the present disclosure.

Referring to FIG. 9, the user data path may be applied to each case in which the user data path is established based on FIG. 7 or FIG. 8, and it may not be limited to a specific form. In one embodiment, a user data path may be established as R1-R3-R5-R7 based on the RID in FIG. 7 or FIG. 8, but this is only a configuration for convenience of explanation and is not limited thereto.

In one embodiment, the SMF may deliver rule and policy information related to the user data path to the TN controller. The TN controller may deliver rules and policies related to the user data path to a router (or node) configured in the TN based on the information received from the SMF. Here, the router may generate the TC and the segment routing header (SRH) for the data delivered from the DN based on the rules and policies related to the user data path obtained from the TN controller. In one embodiment, the SRH may include a segment ID (SID) list and TC information for each path based on the user data path, but may not be limited to a specific embodiment. Here, the SRv6 path may be established by combining a plurality of segments based on the SID list. The SID may consist of a locator, a function, and arguments. The Locator may identify the location of the node and provide IPv6 routing functionality. A function may mean a function executed in each node based on a corresponding packet. In one embodiment, routing (or forwarding) of a corresponding packet at a specific node may be indicated based on a function. The Argument may include parameter information for the function as a secondary field for the function. In one embodiment, a tunnel endpoint identifier (TEID) may be included in the argument.

Specifically, in FIG. 9, the R7 941 may configure an IPv6 payload, an SRH, and an IPv6 header for the data obtained from the DN 950 based on the user data path related information obtained from the TN controller, so that downlink transmission for the user data is performed through another router in the TN. In one embodiment, the SRH may include an RID, and a path through which the user data is transmitted may be determined based on the RID.

Referring to FIG. 9, R7 941 may obtain information about rules and policies for the user data path from the TN controller, as described above. The rules and policies for the user data path may include, but are not limited to, at least one of a downlink packet filter, an SRH encapsulation policy, and transport level packet marking based on TC. When downlink transmission is performed, the R7 941 that has received a payload from the DN 950 may perform encapsulation on the SRH based on at least one of an RID, a TC, a reflective QoS indication (RQI), and a reflective QoS flow to DRB mapping indication (RDI) through information about rule and policy for user data path that has received from the TN controller. Here, the RQI may be information indicating quality of service (QoS) to be reflected, and the RDI may be information indicating data radio bearer (DRB) mapping to a QoS flow. In one embodiment, a service data flow (SDF) based on an IP flow may be mapped to a TC, and the TC may be mapped to each DRB, based on which user data may be delivered.

The R7 941 may deliver the packet consisting of the IPv6 payload, the SRH, and the IPv6 header to the next router based on the rules and policies for the user data path that has received from the TN controller, and the packet may be delivered to the R1 942 based on the corresponding path based on the RID. R1 942 may perform decapsulation for the SRH based on the obtained rule and policy information. Here, the decapsulation is to remove the inserted SRH in R7 941, and the stored RID, TC, RQI, and RDI may be utilized in the cUP 930 connected to R1 942.

The user data may then be delivered to the cUP 930, and the cUP 930 may deliver the data to the UE 910 via the RU/DU 920. The cUP 930 may configure a service data adaptation protocol (SDAP) layer and a packet data convergence protocol (PDCP) layer for data consisting of an IPv6 header and an IPv6 payload, and deliver the data to the RU/DU 920, and after configuring each layer, the RU/DU 920 may deliver data to the UE 910. In one embodiment, the SDAP layer of the packet delivered from the cUP 930 to the RU/DU 920 may include at least one of the RDI, RQI, and RID. In addition, the RU/DU 920 may deliver the above-described RID to the UE 910, which is not limited to a specific form. In another embodiment, the UE 910 may be able to obtain the RID from the RCF, and may not be limited to a specific form.

In addition, in one embodiment, the rule and a policy for user data delivery may also be established in the cUP 930. In a specific embodiment, the CU-UP 930 may be set with the content of Table 2.

TABLE 2

| | |
|---|---|
| 1) | PDR: SDF filtering |
| 2) | Counting of packets |
| 3) | QER: RQI, QFI |
| 4) | eFAR: SRH Decap (TC, RQI) |
| 5) | DRB mapping (TC level) |

In other words, PDR filtering SDF, packet counting, QER including RQI and QFI, eFAR based on decapsulation of SRH, DRB mapping information based on TC level may be established in the cUP 930. Here, packet detection may be unnecessary since decapsulation is performed at a router in the TN to obtain a packet including an IPv6 header and an IPv6 payload. In addition, the cUP 930 may serve as a converged UPF of the RAN and CN, where QoS-related rule and policy may be unnecessary may not need. In one embodiment, the cUP 930 may establish only rules and policies for packet counting and TC-level based DRB mapping information, and may not establish rules and policies related to packet detection and QoS, but is not limited thereto.

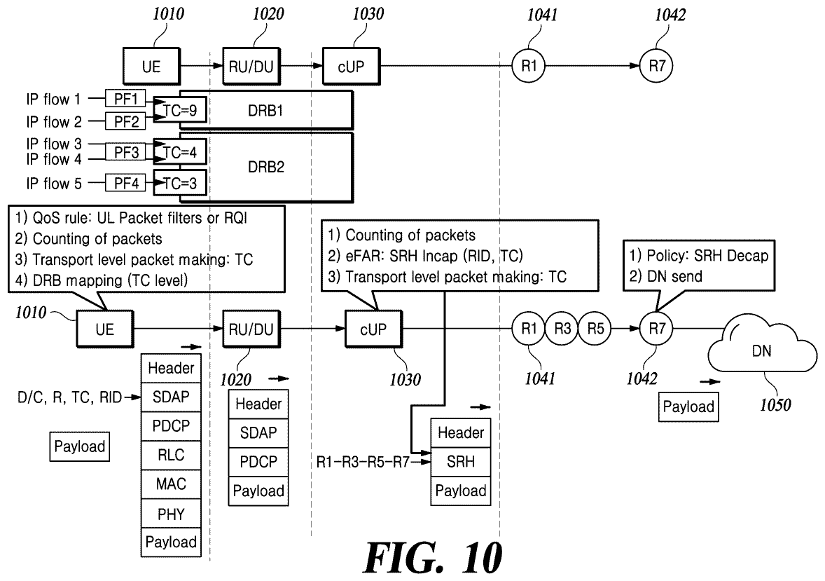

FIG. 10 is a diagram showing a packet forwarding operation in a case of establishing a user data path based on a TN router applicable to the present disclosure.

Referring to FIG. 10, the user data path may be applied to each case in which the user data path is established based on FIG. 7 or FIG. 8, and it may not be limited to a specific form. In one embodiment, a user data path may be established as R1-R3-R5-R7 based on the RID in FIG. 7 or FIG. 8, but this is only a configuration for convenience of explanation and is not limited thereto.

In one embodiment, when uplink transmission is performed based on the TN router, the cUP 1030 may obtain data generated by the UE 1010 through the RU/DU 1020. The cUP 1030 may generate the TC and the SRH for the obtained data based on the user data path related information obtained from the SMF. In one embodiment, the SRH may include an RID, and a path through which the user data is transmitted may be determined based on the RID. The cUP 1030 may configure an IPv6 payload, an SRH, and an IPv6 header for the user data to deliver the packet to R1 1041, a connected router within the TN, thereby allowing uplink transmission for the user data.

In a specific embodiment, in FIG. 10, the cUP 1030 may generate the TC and the SRH based on the user data path related information obtained from the SMF, and deliver the user data to the R1 1041 based on the RID according to the PDR and the eFAR. The R1 1041 may deliver the user data to the next node in the TN based on the delivered TC and RID in the SRH, enabling uplink transmission to be performed.

In one embodiment, when uplink transmission is performed, the UE 1010 may configure each layer in the payload to transmit a packet to the RU/DU 1020. In one embodiment, the UE 1010 may deliver the packet to the RU/DU 1020 based on at least one of QoS rule based on UL packet filter or RQI, packet counting, TC level transport packet marking, and DRB mapping information. Here, the SDAP layer of the packet delivered by the UE 1010 may include, but is not limited to, at least one of data/control (D/C), reserved (R), TC, and RID. The RU/DU 1020 may then deliver the packet to the cUP 1030.

The cUP 1030 may perform encapsulation for the SRH based on the user data path related rule and policy information obtained from the SMF. Specifically, the cUP 1030 may perform encapsulation for the SRH including the RID and the TC based on the eFAR, and deliver a packet including the IPv6 header, the SRH, and the IPv6 payload to the R1 1041. The packet may then travel along a path established based on the RID, and R7 1042 may perform decapsulation based on the policy for SRH decapsulation and deliver the payload to the DN 1050. Here, in one embodiment, the cUP 1030 may be set with the content of Table 3.

TABLE 3

| | |
|---|---|
| 1) | QoS verify |
| 2) | Counting of packets |
| 3) | eFAR: SRH Incap (RID, TC) |
| 4) | Transport level packet making: TC |

In other words, rules and policies for QoS verification, packet counting, eFAR, and TC level transport packet marking may be established in the cUP 1030. In another embodiment, the cUP 1030 may serve as a converged UPF of the RAN and CN, where QoS verification may be unnecessary, and thus a corresponding rule and policy may not be established. However, this is only an example and is not limited thereto.

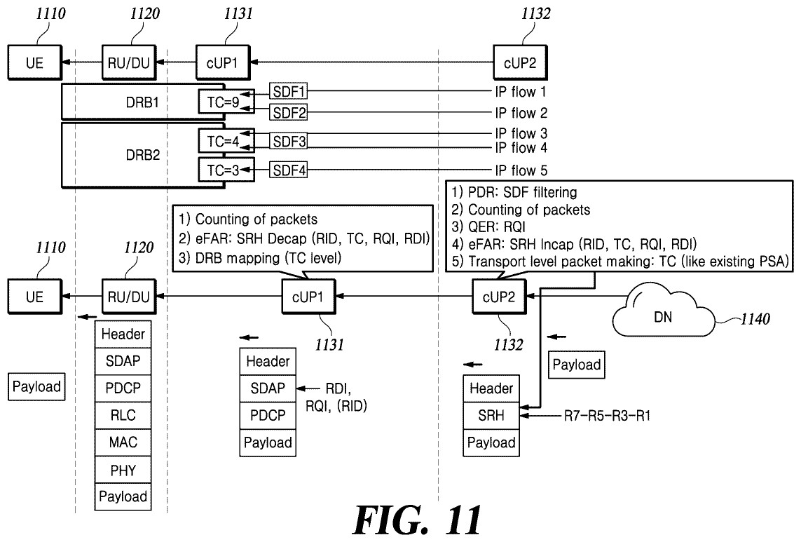

FIG. 11 is a diagram showing a packet forwarding operation in a case of establishing a user data path based on a cUP applicable to the present disclosure.

Referring to FIG. 11, the user data path may be applied to each case in which the user data path is established based on FIG. 7 or FIG. 8, and it may not be limited to a specific form. In one embodiment, a user data path may be established as R1-R3-R5-R7 based on the RID in FIG. 7 or FIG. 8, but this is only a configuration for convenience of explanation and is not limited thereto.

Here, in one embodiment, the user data path may be established based on the cUP. More specifically, referring to FIG. 11, the cUP2 1132 may generate the TC and the SRH based on a rule and policy related to the user data path obtained from the SMF. The cUP2 1132 may configure an IPv6 payload, an SRH, and an IPv6 header for the generated data, and deliver the packet to a router in the TN. Specifically, in FIG. 11, the cUP2 1132 may obtain the rule and policy information related to the user data path from the SMF. Here, the cUP2 1132 may generate the TC and SRH based on the RID, and deliver the packet consisting of the IPv6 payload, the SRH, and the IPv6 header to the router in the TN, and user data transmission may be performed based thereon.

Here, when downlink transmission is performed, the cUP2 1132 may obtain information about the rules and policies for the user data path from the SMF. In one embodiment, the information about the rules and policies for the user data path may include at least one of PDR based on SDF filtering, packet counting, QER including RQI and QFI, eFAR for SRH encapsulation, and TC level transport packet marking information. The cUP2 1132 may obtain the payload from the DN 1140, perform encapsulation on the SHR, and deliver the packet including the IPv6 header, the SRH, and the IPv6 payload through the TN. In one embodiment, the SRH encapsulation may be performed based on at least one of RID, TC, RQI, and RDI, but is not limited thereto. Packets may be delivered from cUP2 1132 to cUP1 1131 through each node in the TN and may be decapsulated in cUP1 1331. Here, the decapsulation is to remove the inserted SRH in cUP2 1132, and the stored RID, TC, RQI, RDI may be utilized in cUP1 1131. In one embodiment, the cUP1 1131 may be set with the content of Table 4.

TABLE 4

| | |
|---|---|
| 1) | PDR: SDF filtering |
| 2) | Counting of packets |
| 3) | QER: RQI, QFI |
| 4) | eFAR: SRH Decap (RID, TC, RQI, RDI) |
| 5) | DRB mapping (TC level) |

In other words, the cUP1 1131 may include at least any one of PDR, packet counting, QER, eFAR for SRH decapsulation, and TC level transport packet marking information as information on rules and policies for the user data path. Here, in one embodiment, since it serves as a converged UPF of the RAN and CN, QoS verification may be unnecessary, and the PDR and QER related to the packet detection and QoS may not be established, but may not be limited thereto. The cUP1 1131 may perform decapsulation based on the rules and policies for the user data path, configure the SDAP layer and the PDCP layer in the payload and deliver to the RU/DU 1120. In one embodiment, the SDAP layer may include, but is not limited to, at least one of RDI, RQI, and RID. That is, the SDAP layer of the packet delivered from the cUP1 1131 to the RU/DU 1120 may include at least one of RDI, RQI, and RID. In addition, the RU/DU 1120 may deliver the above-described RID to the UE 1110, which is not limited to a specific form. In another embodiment, the UE 1110 may be able to obtain the RID from the RCF, and may not be limited to a specific form.

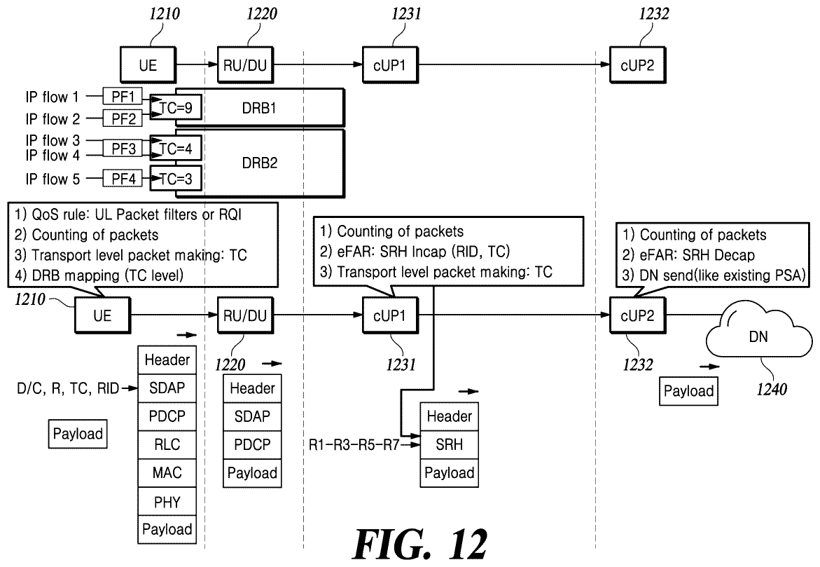

FIG. 12 is a diagram showing a packet forwarding operation in a case of establishing a user data path based on a cUP applicable to the present disclosure.

Referring to FIG. 12, the user data path may be applied to each case in which the user data path is established based on FIG. 7 or FIG. 8, and it may not be limited to a specific form. In one embodiment, a user data path may be established as R1-R3-R5-R7 based on the RID in FIG. 7 or FIG. 8, but this is only a configuration for convenience of explanation and is not limited thereto.

In one embodiment, when the uplink transmission is performed, the cUP1 1231 may generate the TC and the SRH based on the user data path related information obtained from the SMF, and deliver the packet including an IPv6 payload, an SRH, and an IPv6 header to the router in the TN based on the RID. Specifically, when uplink transmission is performed, the UE 1210 may configure each layer in the payload to deliver the packet to the RU/DU 1020. In one embodiment, the UE 1210 may deliver the packet to the RU/DU 1020 based on at least one of QoS rule based on UL packet filter or RQI, packet counting, TC level transport packet marking, and DRB mapping information. Here, the SDAP layer of the packet delivered by the UE 1210 may include, but is not limited to, at least one of D/C, R, TC, and RID. The RU/DU 1220 may then deliver the packet to the cUP1 1231.

The cUP1 1231 may be set with the content of Table 5.

TABLE 5

| | |
|---|---|
| 1) | QoS verify |
| 2) | Counting of packets |
| 3) | eFAR: SRH Incap (RID, TC) |
| 4) | Transport level packet making: TC |

In other words, cUP1 1231 may perform QoS verification, count packets, perform encapsulation for SRH including RID and TC based on eFAR, and deliver packets including the IPv6 header, the SRH and the IPv6 payload through TN. As a further possible embodiment, the cUP1 1231 may serve as a converged UPF of the RAN and CN, so QoS verification may be unnecessary.

The packet may then travel along a path established based on the RID, and cUP2 1232 may perform decapsulation based on the policy for SRH decapsulation and deliver the payload to the DN 1250.

The cUP2 1232 may be set with the content of Table 3.

TABLE 6

| | |
|---|---|
| 1) | QoS verify |
| 2) | Counting of packets |
| 3) | eFAR: SRH Decap |
| 4) | DN send |

(like the existing PSA)

As a further possible implementation, the cUP2 1232, like the cUP1 1231, may serve as a converged UPF of the RAN and CN, so QoS verification may be unnecessary.

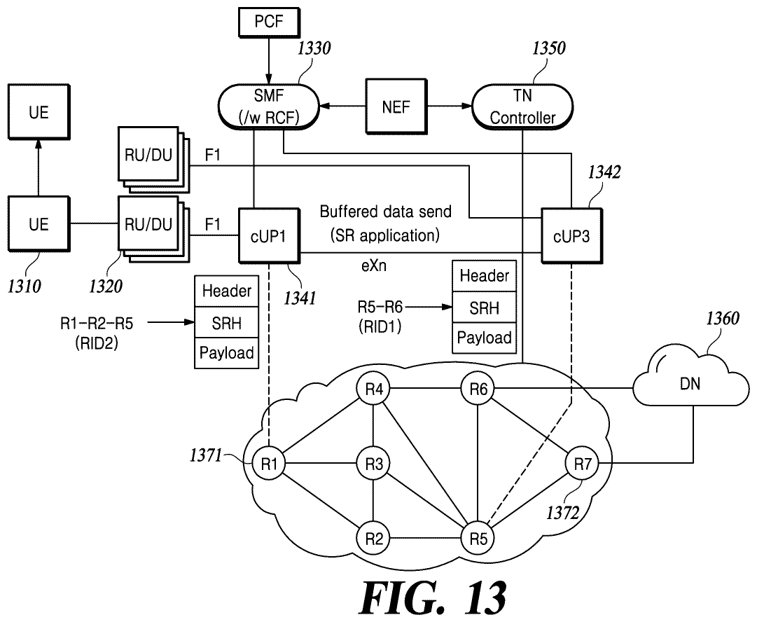

FIG. 13 is a diagram showing a method for delivering buffered data between cUPs based on mobility of a UE applicable to the present disclosure.

Referring to FIG. 13, user data related to the UE 1310 may be delivered via the cUP1 1330 along the RU/DU 1320. Here, the user data may be delivered to the DN 1360 via R1-R3-R5-R7 based on cUP1 in FIG. 7 or FIG. 8 described above. Here, cUP1 may be changed to cUP3 1342 based on mobility. Here, paths of the UE 1310, the cUP3 1342, and the DN 1360 may be established to R5-R6 based on the RID1. In one embodiment, the data buffered in the cUP1 1341 may be delivered to the cUP3 1342 via an R1-R2-R5 path based on the RID2. In a specific embodiment, the TN controller 1350 may establish R5-R6 based on the RID1 as a path for the packets of the UE 1310, the cUP3 1342, and the DN 1360. The SRH of the packet established by the cUP3 1342 may include RID1, and based on this, the payload may be delivered to the DN 1360. Here, the TN controller 1350 may establish R1-R2-R5 based on the RID 2 as a path for delivering the data buffered in the cUP1 1341 to the cUP3 1342. The SRH of the packet established by the cUP1 1341 may include the RID2, and based on this, the packet may be delivered to the R1-R2-R5. Here, an SR function may be recognized in the eXn interface, enabling the transmission of buffered data based on this.

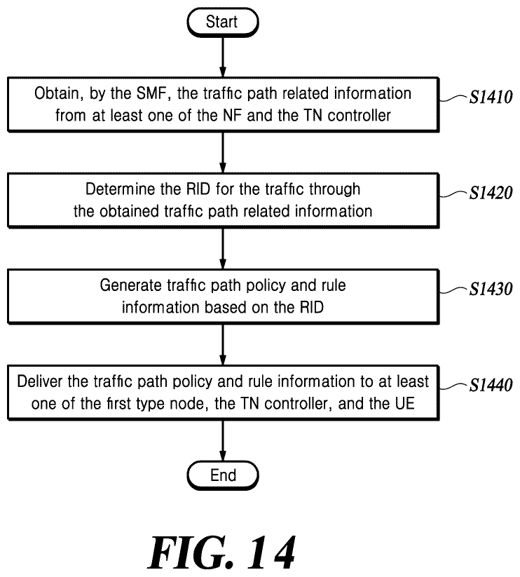

FIG. 14 is a flowchart showing a method for establishing a traffic path in a convergence network applicable to the present disclosure.

Referring to FIG. 14, in the RAN-CN-TN convergence network, the SMF may obtain the traffic path related information from at least one of the NF and the TN controller. (S1410) Here, since it is a RAN-CN-TN convergence network, the SMF may exchange information with the TN controller. In one embodiment, the SMF may exchange information with the TN controller via the NEF, as described above.

Then, the SMF may determine an RID for a traffic through the obtained traffic path related information. (S1420) Here, the RID for the traffic may be calculated through the RCF and returned to the SMF. In addition, the traffic is traffic for a specific application or a specific service, and the RID may be determined for each application or service. That is, the SMF may receive, from the RCF, the RID for the traffic related to the specific application or service, and determine the RID. The SMF may generate traffic path policy and rule information based on the RID. (S1430) In the present specification, “traffic policy and rule information” refers to “policy and rule information related to traffic paths”. The traffic path policy and rule information may include PDR, eFAR, and other policy information, and may not be limited to a specific form. Then, the SMF may deliver the traffic path policy and rule information to at least any one of the first type node, the TN controller, and the UE. (S1440) Here, the first type node may be, but is not limited to, the cUP described above as the RAN-CN converged UPF.

In one embodiment, when downlink transmission for the traffic is performed, the TN controller may receive the traffic path policy and rule information from the SMF. Here, the TN controller may deliver the traffic path policy and rule information based on the RID to the second type node. The second type node may be each node that configures the TN. In an embodiment, the R7 may be a second type node. The second type node may generate the TC and the SRH based on the traffic path policy and rule information for the traffic, and may deliver the traffic via the path according to the RID. On the other hand, when the uplink transmission for the traffic is performed, the first type node that has received the traffic path policy and rule information from the SMF may generate the TC and the SRH based on the traffic path policy and rule information based on the RID, to deliver the traffic on the path according to the RID. Here, the first type node may be the cUP1, but is not limited thereto.

In another embodiment, both downlink and uplink for the traffic may be controlled by the first type node. Each of the first type nodes that has received the traffic path policy and rule information from the SMF may generate the TC and the SRH based on the traffic path policy and rule information based on the RID to deliver the traffic via the path according to the RID, as described above.

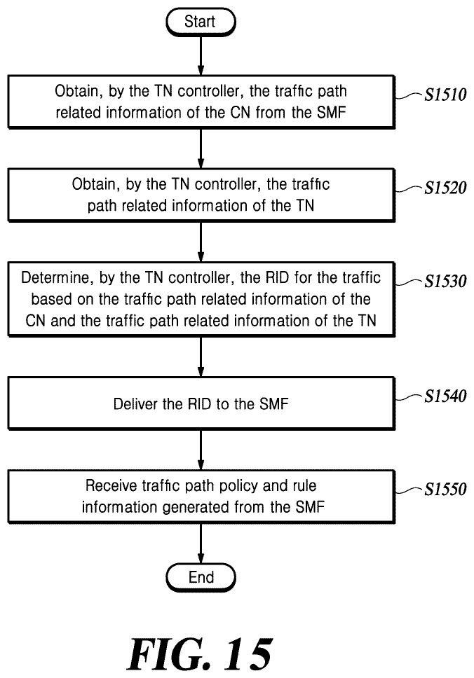

FIG. 15 is a flowchart showing a method for establishing a traffic path in a convergence network applicable to the present disclosure.

Referring to FIG. 15, in the RAN-CN-TN convergence network, the TN controller may obtain the traffic path related information of the CN from the SMF. (S1510) In an embodiment, the TN controller may obtain the traffic path related information of the CN from the SMF through the NEF.

In addition, the TN controller may directly obtain the traffic path related information of the TN, as described above. (S1520) The TN controller may determine an RID for the traffic based on the traffic path related information of the CN and the traffic path related information of the TN (S1530), and deliver the RID to the SMF. (S1540) The TN controller may then receive the generated traffic path policy and rule information from the SMF. (S1550). The SMF may deliver the traffic path policy and rule information to at least any one of the TN controller, the first type node, and the UE. Here, the first type node may be, but is not limited to, the cUP described above as the RAN-CN converged UPF.

In one embodiment, when downlink transmission for the traffic is performed, the TN controller may receive the traffic path policy and rule information from the SMF. Here, the TN controller may deliver the traffic path policy and rule information based on the RID to the second type node. The second type node may be each node that configures the TN. In one embodiment, the above-described R7 may be second type node. The second type node may generate the TC and the SRH based on the traffic path policy and rule information for the traffic, and may deliver the traffic via the path according to the RID. On the other hand, when the uplink transmission for the traffic is performed, the first type node that has received the traffic path policy and rule information from the SMF may generate the TC and the SRH based on the traffic path policy and rule information based on the RID, to deliver the traffic over the path according to the RID. Here, the first type node may be, but is not limited to, the cUP1.

In another embodiment, both downlink and uplink for the traffic may be controlled by the first type node. Each of the first type nodes that have received the traffic path policy and rule information from the SMF may generate the TC and the SRH based on the traffic path policy and rule information based on the RID to deliver the traffic via the path according to the RID, as described above.

At least some components described in the exemplary embodiments of the present disclosure may be implemented as hardware elements including at least one or a combination of digital signal processor (DSP), processor, controller, application-specific IC (ASIC), programmable logic device (FPGA, etc.), and other electronic devices. In addition, at least some functions or processes described in the exemplary embodiments may be implemented by software, and the software may be stored in a recording medium. At least some components, functions, and processes described in the exemplary embodiments of the present disclosure may be implemented by a combination of hardware and software.

The method according to the exemplary embodiments of the present disclosure may be written as a computer-executable program, and may also be implemented as various recording media such as a magnetic storage medium, an optical reading medium, and a digital storage medium.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, for example, in a machine-readable storage device (computer-readable medium) or in a propagated signal, for processing by, or to control the operation of, data processing apparatus, e.g., a programmable processor, a computer, or multiple computers. A computer program, such as the computer program(s) described above, may be written in any form of programming language, including compiled or interpreted languages, and it may be deployed in any form, including as a stand-alone program or as a module, component, subroutine, or other unit suitable for use in a computing environment. A computer program may be deployed to be processed on one computer or on multiple computers at one site or distributed across multiple sites and interconnected by a communication network.

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer will include, or be coupled to receive data from or transmit data to, or both, one or more mass storage devices for storing data, e.g., magnetic, magneto-optical disks, or optical disks. Information carriers suitable for embodying computer program instructions and data include, by way of example, semiconductor memory devices, magnetic media such as hard disks, floppy disks, and magnetic tape, optical media such as compact disk read only memory (CD-ROM), digital video disk (DVD), magneto-optical media such as floptical disks, read only memory (ROM), random access memory (RAM), flash memory, erasable programmable ROM (EPROM), electrically erasable programmeable ROM (EEPROM), and the like. The processor and the memory may be supplemented by, or incorporated in, special purpose logic circuitry.

The processor may execute an operating system and a software application executed on the operating system. Further, the processor device may access, store, manipulate, process, and generate data in response to execution of the software. For ease of understanding, it may be described that one processor device is used, but a person skilled in the art may know that the processor device may include a plurality of processing elements and/or a plurality of types of processing elements. For example, the processor device may include a plurality of processors or one processor and one controller. Other processing configurations, such as parallel processors, are also possible.

Moreover, non-transitory computer-readable media may be any available media that may be accessed by a computer and includes both computer storage media and transmission media.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain cases, multitasking and parallel processing may be advantageous. Moreover, the separation of various device components in the embodiments described above should not be understood as requiring such separation in all embodiments, and it should be understood that the described program components and devices may generally be integrated together in a single software product or packaged into multiple software products.

It should be noted that the embodiments of the present disclosure disclosed in the specification and the drawings are merely specific examples for facilitating understanding, and are not intended to limit the scope of the present disclosure. It is obvious to a person skilled in the art that other variations based on the technical idea of the present disclosure may be implemented in addition to the embodiments disclosed herein.

The protection scope of the present embodiment is to be construed according to the following claims, and all technical ideas within the scope equivalent thereto are construed as being included in the scope of rights of the present embodiment.

What is claimed is:

1. A method for establishing a traffic path in radio access network (RAN)-core network (CN)-transport network (TN) convergence network, the method comprising:
obtaining, by a session management function (SMF), traffic path related information from at least one of a network function (NF) and a TN controller;
determining a routing identification (RID) for a traffic using the obtained traffic path related information;
generating policy and rule information related to traffic paths based on the RID; and
delivering the policy and rule information to at least one of a first type node, the TN controller, and a user equipment (UE).

2. The method of claim 1, wherein:
the SMF obtains the traffic path related information from the TN controller through a network exposure function (NEF); and
the SMF obtains the RID generated by a routing control function (RCF).

3. The method of claim 1, wherein:
if downlink transmission is performed, the TN controller that has received the policy and rule information from the SMF delivers the policy and rule information based on the RID to a second type node, and the second type node generates a traffic classification (TC) and a segment routing header (SRH), based on the policy and rule information, to deliver the traffic through path according to the RID.

4. The method of claim 3, wherein:
if uplink transmission is performed, the first type node that has received the policy and rule information from the SMF generates TC and SRH, based on the policy and rule information based on the RID, to deliver the traffic through path according to the RID.

5. The method of claim 1, wherein:
if downlink transmission is performed, the first type node that has received the policy and rule information from the SMF generates TC and SRH, based on the policy and rule information based on the RID, to deliver the traffic through path according to the RID.

6. The method of claim 5, wherein:
if uplink transmission is performed, the first type node that has received the policy and rule information from the SMF generates TC and SRH, based on the policy and rule information based on the RID, to deliver the traffic through path according to the RID.

7. The method of claim 3, wherein:
the first type node is a RAN-CN converged user plane function (UPF), and the second type node is a node constituting the TN.

8. An apparatus for establishing a traffic path in radio access network (RAN)-core network (CN)-transport network (TN) convergence network, the apparatus comprising:
a memory storing at least one program;
a transceiver transmitting and receiving at least one signal; and
a processor executing the at least one program stored in the memory,
wherein the processor is configured to:
obtain traffic path related information from at least one of a network function (NF) and a TN controller;
determine a routing identification (RID) for a traffic using the obtained traffic path related information;
generate policy and rule information related to traffic paths based on the RID; and
deliver the policy and rule information to at least one of a first type node, the TN controller, and a user equipment (UE).

9. The apparatus of claim 8, wherein:
the SMF obtains the traffic path related information from the TN controller through a network exposure function (NEF); and
the SMF obtains the RID generated by routing control function (RCF).

10. The apparatus of claim 8, wherein:
if downlink transmission is performed, the TN controller that has received the policy and rule information from the SMF delivers the policy and rule information based on the RID to a second type node, and the second type node generates TC and SRH, based on the policy and rule information, to deliver the traffic through path according to the RID.

11. The apparatus of claim 10, wherein:
if uplink transmission is performed, the first type node that has received the policy and rule information from the SMF generates TC and SRH, based on the policy and rule information based on the RID, to deliver the traffic through path according to the RID.

12. The apparatus of claim 8, wherein:
if downlink transmission is performed, the first type node that has received the policy and rule information from the SMF generates TC and SRH, based on the policy and rule information based on the RID, to deliver the traffic through path according to the RID.

13. The apparatus of claim 12, wherein:
if uplink transmission is performed, the first type node that has received the policy and rule information from the SMF generates TC and SRH, based on the policy and rule information based on the RID, to deliver the traffic through path according to the RID.

14. The apparatus of claim 10, wherein:
the first type node is a RAN-CN converged user plane function (UPF), and the second type node is a node constituting the TN.

15. A method for establishing traffic path in radio access network (RAN)-core network (CN)-transport network (TN) convergence network, the method comprising:
obtaining, by the TN controller, traffic path related information of CN from a session management function (SMF);
obtaining, by the TN controller, traffic path related information of TN;
determining, by the TN controller, a routing identification (RID) for a traffic based on the traffic path related information of the CN and the traffic path related information of the TN;
delivering the RID to the SMF; and
receiving policy and rule information related to traffic paths generated from the SMF.

16. The method of claim 15, wherein:
the TN controller obtains traffic path related information of the CN from the SMF through a network exposure function (NEF).

17. The method of claim 15, wherein:
the SMF delivers the policy and rule information to at least one of the TN controller, a first type node, and a user equipment (UE).

18. The method of claim 15, wherein:
if downlink transmission is performed, the TN controller that has received the policy and rule information from the SMF delivers the policy and rule information based on the RID to a second type node, and the second type node generates TC and SRH, based on the policy and rule information, to deliver the traffic through path according to the RID; and
if uplink transmission is performed, the first type node that has received the policy and rule information from the SMF generates TC and SRH, based on the policy and rule information based on the RID, to deliver the traffic through path according to the RID.

19. The method of claim 15, wherein:
if downlink transmission is performed, the first type node that has received the policy and rule information from the SMF generates TC and SRH, based on the policy and rule information based on the RID, to deliver the traffic through path according to the RID; and
if uplink transmission is performed, the first type node that has received the policy and rule information from the SMF generates TC and SRH, based on the policy and rule information based on the RID, to deliver the traffic through path according to the RID.

20. The method of claim 18, wherein:
the first type node is a RAN-CN converged user plane function (UPF), and the second type node is a node constituting the TN.
